(19) United States
(12) Patent Application Publication
(10) Pub. No.: US 2015/0100883 A1
(43) Pub. Date: Apr. 9, 2015

(54) MEDIA CONTENT MANAGEMENT SYSTEM AND DEVICE

(71) Applicant: Austin B. Kern, Newport Beach, CA (US)

(72) Inventor: Austin B. Kern, Newport Beach, CA (US)

(21) Appl. No.: 14/047,912

(22) Filed: Oct. 7, 2013

(51) Int. Cl. H04L 29/06

(52) U.S. Cl. CPC H04L 65/60
USPC 715/716

(57) ABSTRACT

A media management system for managing digital media of a user, comprising: a media management device communicatively coupled with a server configured to store digital media, the media management device having: a digital media storage medium drive configured to extract digital media stored on a storage medium; a transceiver configured to transmit the digital media to the server for storage; and at least one end-user interface device communicatively coupled with the server, and in combination with the server configured to permit the user to manage the digital media.

### BACKGROUND OF THE INVENTION

The use of digital media is both prevalent and increasing. Digital media is any media that may be stored, transmitted, and/or received in digital format. Music, videos, games, and other forms of media are commonly stored, transmitted and/or received as digital media.

Digital media management systems are known to organize a user's digital media collection into one or more libraries of digital media that may then be referred to by the user seeking to utilize his/her digital media, e.g. listen to music.

Some digital media management systems, such as the popular iTunes®, require that the managed digital media be locally stored, for example, by a local memory. This, of course, necessitates the existence of a locally stored collection of digital media. In other words, the user must typically import his/her digital media to a source desktop computer before he/she is able to access it via the management system. Conventionally, this has been accomplished by “ripping” a digital storage medium (e.g. a CD/DVD) containing the digital media using a drive (e.g. an optical disk drive) of the source desktop computer. Unfortunately, because the digital media must be locally stored, the availability of the digital media to the user is limited. Moreover, large locally stored libraries consume large amounts of memory.

There are cloud computing music management systems that attempt to solve this availability problem for digital music by providing selective access to a common cloud-based collection of digital music files. Examples of these types of systems include iTunes Match® and Amazon C1oudPlayer®. Users of these types of management systems upload their locally stored music files to the system server. The system server then matches the uploaded music file to an analogous cloud-based file, and permits the user access to the analogous cloud-based file from any computing device capable of operating the management software. Thus, a virtual copy of the user's library is reproduced on each of his/her devices via the cloud.

However, these systems still require an initial “ripping” and upload of the digital music from a physical digital storage medium before access to the analogous cloud-based file is permitted—generally through a desktop computer drive. With the increasing preference towards tablets and other computing devices without such drives as the primary vehicle through which digital media is both experienced and managed, it is becoming increasingly impractical to maintain a separate desktop computer for the sole purpose of digital media management/storage.

Alternative solutions have developed for which no desktop computer is necessary. These so-called pure cloud-based music management systems, such as Spotify®, maintain large libraries of music filed that are accessible to users pursuant to a subscription. Unfortunately, there is no ability for the user to listen to music outside the system library. Thus, if the user desires to listen to a song that is not available through the pure cloud-based system, he/she must still rely on a locally stored file. Moreover, access to the cloud-based music and any customized libraries, playlists, ratings, etc. are dependent on maintaining a subscription.

### SUMMARY OF THE INVENTION

A media content management system and device is described herein that overcomes the limitations noted above.

A media management system for managing digital media of a user is provided, comprising: a media management device communicatively coupled with a server configured to store digital media, the media management device having: a digital media storage medium drive configured to extract digital media stored on a storage medium; a transceiver configured to transmit the digital media to the server for storage; and at least one end-user interface device communicatively coupled with the server, and in combination with the server configured to permit the user to manage the digital media.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 illustrates a media management system according to a preferred embodiment of the present invention;

FIG. 2 illustrates a media management device according to a preferred embodiment of the present invention;

FIG. 3 illustrates a media management process according to a preferred embodiment of the present invention.

### DETAILED DESCRIPTION OF THE PREFERRED EMBODIMENTS

The above described drawing figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. Therefore, it should be understood that what is illustrated is set forth only for the purposes of example and should not be taken as a limitation on the scope of the present apparatus and its method of use.

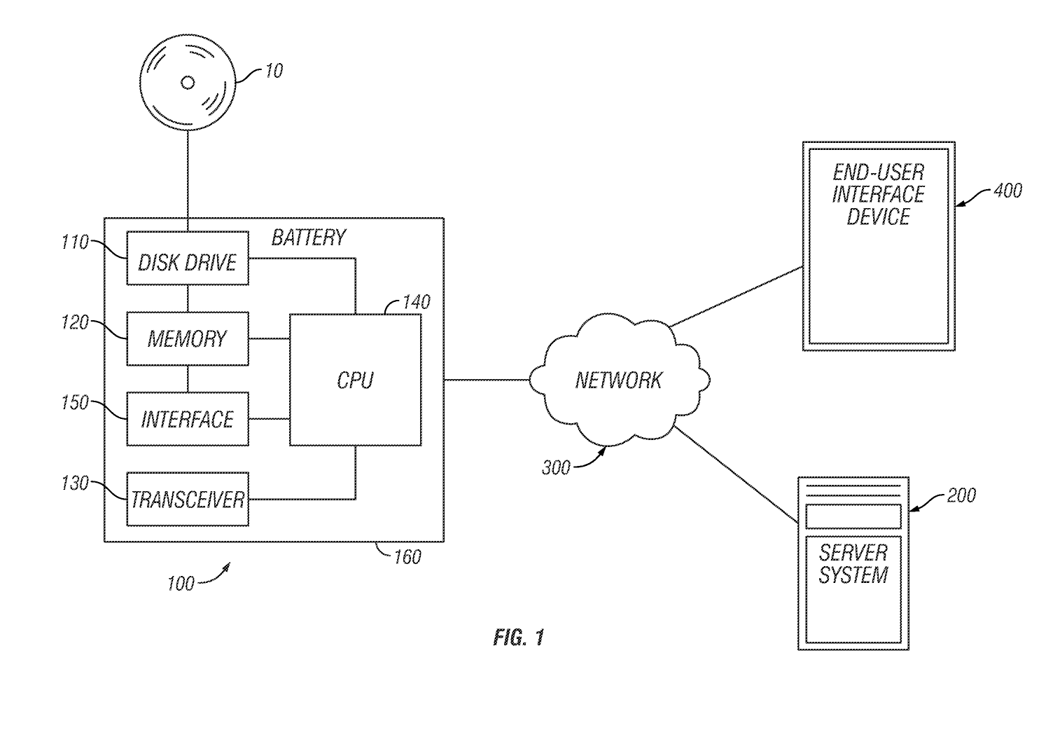

FIG. 1 illustrates a media management system according to at least one embodiment of the present invention. The media management system generally includes a media management device 100; a server system 200, which may distributed on one or more physical servers, each having processor, memory, an operating system, and input/output interface, and a network interface, all known in the art; and at least one end user interface device 400, having a processor, a memory, an operating system, an input/output interface, a graphical interface, and a network interface, each of the media management device, server system and end user interface being coupled to a public network 300, such as the Internet.

In general terms, the media management system permits a user to extract his/her digital media from a storage medium 10, such as CD/DVDs, SD cards, flash memory units, etc. via the media management device, and upload it to the server system, via the network, where the digital media may be experienced by the user, via the end user interface device. The server system generally includes a computer application designed to manage the extracted digital media, whereas the end user interface generally provides the user the ability to interface with the media management computer application so as to manage the extracted digital media. As used herein, the term “digital media” generally refers to one or more of: digital media content data, and verification data authorizing access to digital media content data. As used herein, “digital media” may include video recordings, audio recordings, multimedia presentations, text, online content, interactive media (e.g. video games), etc.

### MEDIA MANAGEMENT DEVICE

An exemplary embodiment of the media management device 100 is shown in FIG. 1. The media management device generally includes an digital media drive 110 for extracting digital media stored on a storage medium 10, a memory 120 for storing the extracted digital media, a transceiver 130 for transmitting the digital media to the server system via the network, and a controller 140 electronically coupled to and controlling the operation of the digital media drive, the memory and the transceiver, as described herein according to a set of software instructions retrievably stored in the memory.

The digital media drive 110 is electronically coupled to the memory 120 and the controller 140, and is operable to extract digital media files from the storage medium 10. Preferably, the digital media drive is an optical disk drive. However, other media storage devices may be utilized without departing from the scope of the invention, including SD drives, USB drives, flash memory drives etc. Preferably, the digital media drive is capable of extracting the digital media files at a rate and/or quality level selected from among a plurality of rates and/or quality levels. In at least one embodiment, a plurality of digital media drives are provided according to the description set forth herein, so as to enable the simultaneous extraction of digital media from a plurality of storage mediums.

The memory 120 is electronically coupled to the transceiver 130 and the controller 140, and is operable to receive and retrievably store the digital media extracted from the storage medium. Preferably, the memory is a data buffer or cache, temporarily storing the digital media while it is being moved from the digital media drive to the transceiver for transmission to the server system. Accordingly, the memory need not be overly large and production costs may be minimized. However, in at least one embodiment, the memory is of sufficient capacity to store one or more complete digital media files, e.g. an entire song or video.

The transceiver 130 is electronically coupled to the memory 120 and the controller 140, and is operable to retrieve the digital media from the memory, and to transmit the digital media to the server system 200 via the network 300. The transceiver may transmit over a wireless, wired, cellular, or any other type of network now known or hereafter developed. Preferably, the transceiver is a wireless network transceiver which may communicate with a Wireless Area Network (“WAN”) such as a Wifi network in accordance with IEEE 802.11 or a Personal Area Network (“PAN”) such as Bluetooth or Near Field Communications technology. In at least some embodiments, transmission occurs automatically upon extraction of the digital media.

As described herein, the controller 140 controls the operation of the digital media drive 110, the memory 120 and the transceiver 130, according to a set of software instructions retrievably stored in the memory 120. The controller causes the digital drive to extract the digital media from the storage medium and communicate the digital media to the memory. The controller additionally causes the memory to receive and retrievably store the digital media. And the controller causes the transceiver to retrieve the digital media from the memory and transmit it to the server system via the network.

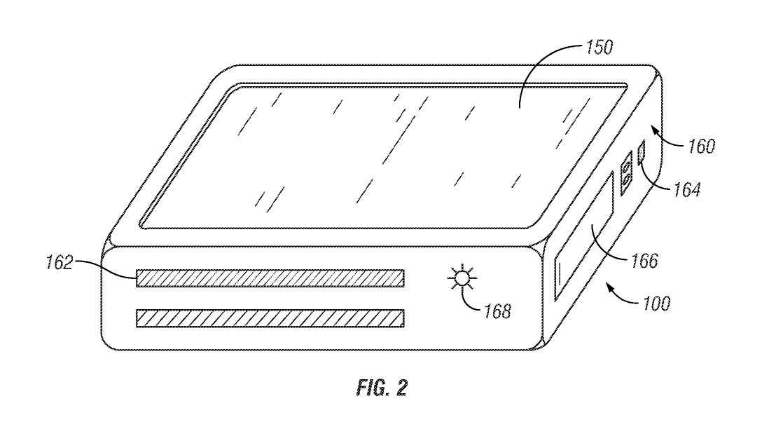

As shown in FIG. 2, in at least one preferred embodiment, a case 160 operates to form a protective housing for the media management device 100.

The case may include one or more apertures 162 exposing one or more digital media drives therein so as to permit the function coupling of the storage medium and the digital media drive. Preferably, the case includes at least one aperture exposing an optical disk drive and permitting insertion of an optical disk therein.

The case may further include a user accessible power button 164 in electrical communication with the media management device, and operable to switch the media management device between an on-state and an off-state. The case may further include an electrical power source 166 for powering the media management device. The electrical power source may include one or more of: a power inlet for accepting a power chord; a battery compartment for housing replaceable batteries; and a rechargeable battery compartment for housing a rechargeable battery.

The case may also include one or more status indicator lights 168, each in electrical communication with the controller and operable to indicate a status of the media management device. Such status may include an on/off status, a transmitting status, and/or a wireless connectivity status.

### DIRECT UPLOAD

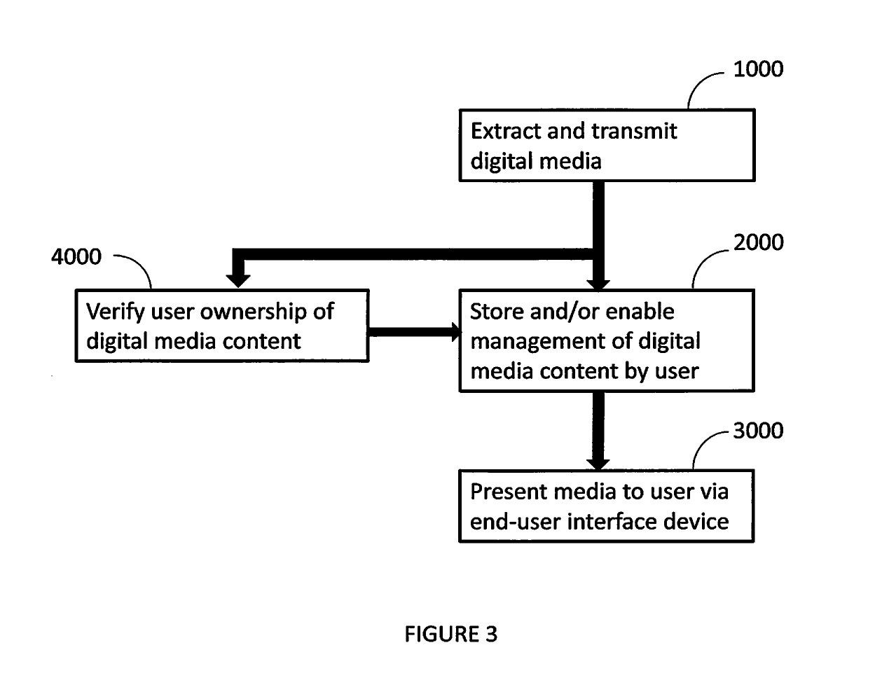

Turning now to FIG. 3, as discussed herein, the media management device extracts the digital media from the storage medium and transmits the digital media to the server system, via the network, where it is retrievably stored on at least one database in a digital media library associated with the user (Step 1000). The speed of the data transfer, i.e. the upload speed, may be variable. Indeed, the speed may be selectable by the user. For example, the user may select a high/low transfer rate that corresponds to a low/high quality rate for the transfer of certain digital media according to the needs of the user related to the digital media.

The uploaded and stored digital media library is then subject to management by the user via the end-user interface device (Step 2000). As described herein, the server system generally includes a computer application designed to manage digital media files located in the digital media library. The computer application preferably permits the user to add/delete/modify digital media files located in the library, create playlists, add/delete/modify metadata and/or other tags, add/delete/modify permissions (i.e. what end-user devices are authorized to present the digital media to the user—e.g. a child's iPad may be restricted from presenting certain songs or videos so as to effectuate a ‘child-lock’ feature), verify digital media ownership, and purchase and/or download digital media from the Internet.

Accordingly, the user's digital media may be added directly to the user's cloud-based digital media library without the need for a local database—i.e. without the need for an expensive and inconvenient personal computer.

The user may experience the digital media via the end-user interface (Step 3000), which may include a tablet, a laptop, a desktop, a smartphone, a PDA, an MP3 player, a media streaming device, a video gaming console. The end-user interface may stream the digital media from the server system, or it may download the digital media prior to presenting it to the user. In at least one embodiment, the end-user interface permits both. Further, the end-user interface may be equipped to operate the media management computer application so as to enable user management of the digital library from the end-user interface.

In at least one embodiment, the end-user interface provides the user with the ability to interface with the server and/or the media management device via the media management computer application. In this way, the user is able to manage his/her digital media library and/or control the media management device.

### VERIFICATION

As shown in FIG. 3, in at least one embodiment, the server system—via the media management computer application—operates to verify the user's ownership of digital media content so as to permit user library access to a copy of the digital media content already stored on the database (Step 4000).

In at least one embodiment, a “dummy” storage medium is used to upload verification data to the server system to be utilized for verifying user ownership of associated digital media. For example, a dummy disk purchased by the user may store verification data for one or more songs stored on the server database. The user may utilize the media management device to extract and upload the verification data according to the embodiments described herein. Upon the completion of the verification data upload, the media management computer application may authorize access to associated digital media content pre-stored by the server system. In other words, the server system database may include a collection of digital media content, and each user's library may at least partially comprise virtual copies of the specific digital media content, made accessible to the user's library upon successful verification of the user's ownership of the specific song, movie, etc. that the digital media content corresponds to.

In at least one embodiment, verification may occur via online purchase of a digital media file from a third-party website. Such verification may provide access to the digital media stored on a third-party server system database by the user's library.

In at least one embodiment, a portion of the digital media content, and/or a low quality extraction, is used as verification data. For example, the media management device may upload a low quality version of the digital media at a high transfer rate. The media management computer application may then identify and compare the low quality version to the associated fully quality version of the digital media content stored on the database, such comparison functioning as a verification of ownership and resulting in the digital media being accessible to the user via the user's library.

According to at least one embodiment, the media management system may be used to verify digital media available through subscription services. For example, the media management device may upload verification data (including low quality content) from a rented DVD, that is then used to verify that the user is authorized to view the DVD. The authorized digital media can then be added to the user's library for a period of time corresponding to the rental.

### LIBRARY CONTROLLED FROM MEDIA MANAGEMENT DEVICE

Turning now to FIG. 2, in at least one preferred embodiment, the media management device is operable to present the digital media to the user, and/or to permit the user to manage his/her digital medial library. Accordingly, the media management device may include a graphical user interface 150 (GUI) exposed within the case, and electronically coupled to the memory and the controller for operation thereof.

In at least one embodiment, the controller may cause the GUI to retrieve and present the digital media to the user. This presentation may be an audio/visual display, such as playing a movie or song, or other media presentation. As discussed above, in at least one embodiment, the memory is of sufficient capacity to store one or more complete digital media files, e.g. an entire song or video, for playback. Preferably, the GUI is a touch-screen display and the media management device is be configured to operate the media management computer application, permitting the user to manage his/her digital media library via the GUI. Accordingly, the media management device may be a self-contained unit permitting direct uploading and management of digital media, and permitting presentation of the uploaded digital media to the user.

### REVERSE—RIPPING FROM DATABASE

In at least one preferred embodiment, the media management device is operable to permit the user to transfer digital media from the user's library to a storage medium. Accordingly, the transceiver receives digital media from the server via the network, for example, in the form of a playlist. The transceiver communicates the received digital media to the memory where it is retrievably stored. The digital media drive retrieves the stored digital media and ‘burns’ the digital media to a storage medium in communication with the drive.

The enablements described in detail above are considered novel over the prior art of record and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. A media management system for managing digital media library of a user, comprising:
a handheld media management device in wireless communication with a server configured to store digital media, the media management device having:
an optical disk drive configured to extract digital media stored on an optical disk;
a transceiver configured to wirelessly transmit the digital media to the server for storage thereon; and
at least one end-user interface device communicatively coupled with the server, and in combination with the server, configured to permit the user to manage the digital media as part of the user's digital library.

2. The media management system of claim 1, wherein the media management device further includes a rechargeable battery for powering the device.

3. The media management system of claim 1,
wherein the digital media includes verification data, and
wherein the server is further configured to add digital media content associated with the verification data to the user's digital media library on receipt of the associated verification data.

4. The media management system of claim 1, wherein permitting the user to manage the digital media as part of the user's digital library, includes at least one of: adding, removing, modifying, and grouping digital media files.

5. The media management system of claim 1, wherein the extracted digital media is transmitted directly from the media management device to the server system.

6. The media management system of claim 1, wherein the end-user interface device includes at least one of: a tablet, a laptop, a desktop, a smartphone, a PDA, an MP3 player, a media streaming device, and a gaming console.

7. The media management system of claim 1, wherein the media management device further includes a touch screen graphical user interface configured to permit the user to manage the digital media as part of the user's digital library.
